(19) United States
(12) Patent Application Publication
(10) Pub. No.: US 2013/0086372 A1
(43) Pub. Date: Apr. 4, 2013

(54) INFORMATION PROCESSING APPARATUS AND BOOT CONTROL METHOD

(71) Applicant: Akihiro Kojo, Ome-shi (JP)

(72) Inventor: Akihiro Kojo, Ome-shi (JP)

(21) Appl. No.: 13/495,731

(22) Filed: Jun. 13, 2012

(30) Foreign Application Priority Data
Sep. 30, 2011 (JP) 2011-217329

(51) Int. Cl. G06F 9/00; G06F 1/26

(52) U.S. Cl. 713/2

(57) ABSTRACT

According to one embodiment, an information processing apparatus, to which devices are connected, includes a device information detector, a device setting module and an information storage module. The device information detector detects device information from the devices when the apparatus is booted at a first timing. The device setting module sets the devices to be ready to use using the information. The information storage module stores the information in a nonvolatile memory. The device setting module sets the devices to be ready to use using the information in the nonvolatile memory when the apparatus is booted at a second timing after the first timing.

### CROSS-REFERENCE TO RELATED APPLICATIONS

This application is based upon and claims the benefit of priority from prior Japanese Patent Application No. 2011-217329, filed Sep. 30, 2011, the entire contents of which are incorporated herein by reference.

### FIELD

Embodiments described herein relate generally to an information processing apparatus which initializes hardware on boot-up, and a boot control method applied to the apparatus.

### BACKGROUND

In an information processing apparatus such as a personal computer, when that information processing apparatus is booted, a basic input/output system (BIOS) executes boot processing (for example, initialization, configuration, diagnosis, and the like of hardware) of various hardware components. In this hardware boot processing, for example, pieces of information required to use hardware components connected to the information processing apparatus are acquired from the respective hardware components, and resources required for these hardware components are assigned. Thus, the hardware components connected to the information processing apparatus are set to be ready to use. Then, upon completion of the hardware boot processing, an operating system (OS) which runs using these hardware components can be launched.

In the hardware boot processing, for example, a method of providing a normal mode which executes initialization and diagnosis of hardware, and a special mode which executes only initialization of hardware, and allowing the user to select one of these modes according to a user's key input has been proposed. For example, when the user selects the special mode that skips diagnosis of hardware, the time required to boot the information processing apparatus can be reduced.

With the aforementioned method, the period required to boot the information processing apparatus can be shortened by limiting some functions included in the boot processing. However, limitations of functions may impair user's convenience.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing an example of the appearance of an information processing apparatus according to an embodiment.

FIG. 2 is an exemplary block diagram showing an example of the system configuration of the information processing apparatus according to the embodiment.

FIG. 3 is an exemplary block diagram showing an example of the functional configuration of a BIOS boot program executed by the information processing apparatus according to the embodiment.

FIG. 4 is an exemplary view showing an example of device information used by the information processing apparatus according to the embodiment.

FIG. 5 is an exemplary view showing another example of device information used by the information processing apparatus according to the embodiment.

FIG. 6 is an exemplary view showing still another example of device information used by the information processing apparatus according to the embodiment.

FIG. 7 is an exemplary flowchart showing an example of the procedure of BIOS boot processing executed by the information processing apparatus according to the embodiment.

FIG. 8 is an exemplary flowchart showing an example of the procedure of first boot processing executed by the information processing apparatus according to the embodiment.

FIG. 9 is an exemplary flowchart showing an example of the procedure of second boot processing executed by the information processing apparatus according to the embodiment.

### DETAILED DESCRIPTION

Various embodiments will be described hereinafter with reference to the accompanying drawings.

In general, according to one embodiment, an information processing apparatus, to which devices are connected, includes a device information detector, a device setting module, and a device information storage module. The device information detector detects a plurality of pieces of device information from the devices when the information processing apparatus is booted at a first timing, the plurality of pieces of device information being for setting the devices to be ready to use. The device setting module sets the devices to be ready to use using the plurality of pieces of device information. The device information storage module stores the plurality of pieces of device information in a nonvolatile memory. The device setting module sets the devices to be ready to use using the plurality of pieces of device information in the nonvolatile memory when the information processing apparatus is booted at a second timing after the first timing.

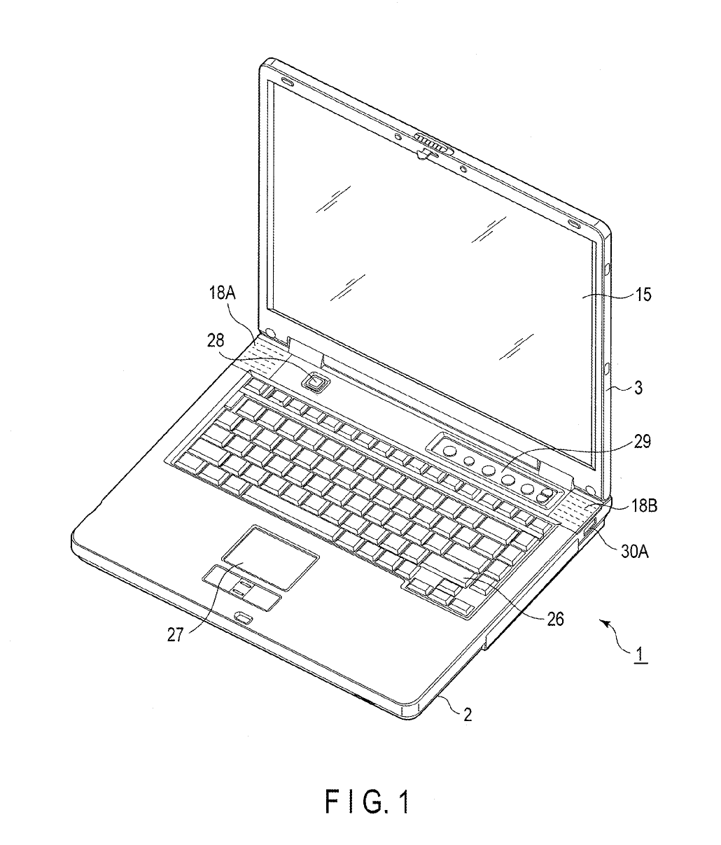

FIG. 1 is a perspective view showing the outer appearance of an information processing apparatus according to one embodiment. This information processing apparatus is implemented as, for example, a notebook type personal computer 1. Alternatively, this information processing apparatus may be implemented as a desktop type PC, tablet PC, PDA, smartphone, or the like.

As shown in FIG. 1, this computer 1 includes a computer main body 2 and display unit 3.

A liquid crystal display (LCD) 15 is built in the display unit 3. The display unit 3 is attached to the computer main body 2 to be freely pivotal between an opening position where the upper surface of the computer main body 2 is exposed, and a closing position where the display unit 3 covers the upper surface of the computer main body 2.

The computer main body 2 has a low-profile, box-shaped housing. A keyboard 26, a power button 28 used to turn on/off the power supply of the computer 1, an input operation panel 29, a touch pad 27, loudspeakers 18A and 18B, and the like are disposed on the upper surface of the computer main body 2. Various operation buttons are arranged on the input operation panel 29. An external device connection terminal 30A conforming to the USB2.0 standard is arranged on, for example, the right side surface of the computer main body 2.

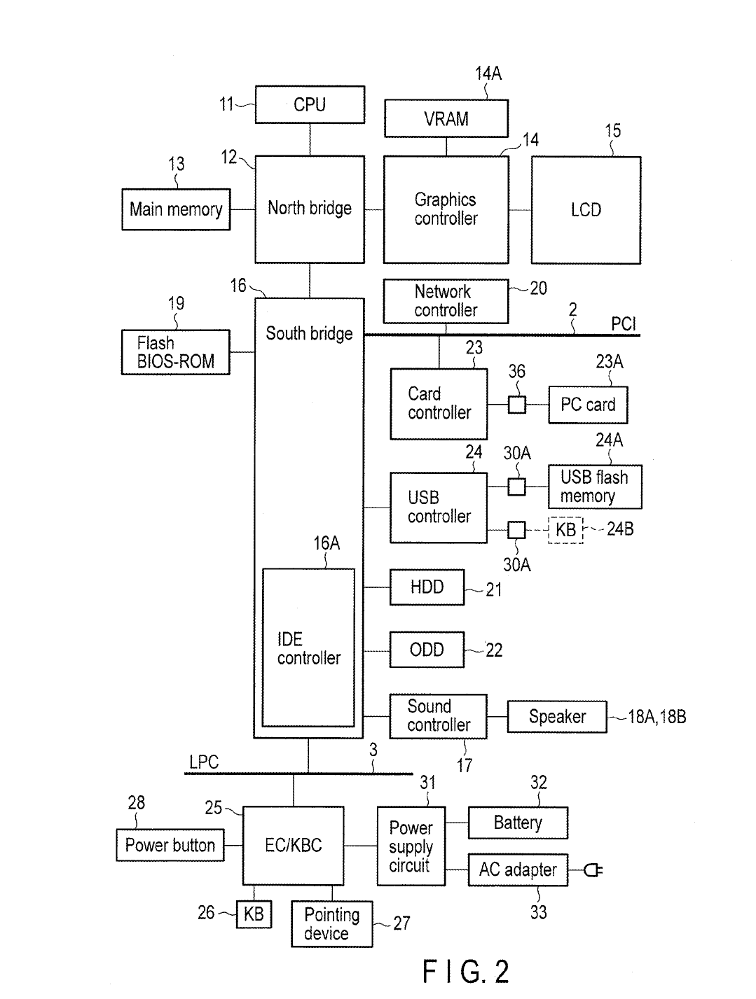

FIG. 2 shows the system configuration of the computer 1.

As shown in FIG. 2, this computer 1 includes a CPU 11, a north bridge 12, a main memory 13, a graphics controller 14, a video memory (VRAM) 14A, a display 15, a south bridge 16, sound controller 17, speakers 18A and 18B, a flash BIOS-ROM 19, a network controller 20, a hard disk drive (HDD) 21, an optical disk drive (ODD) 22, a card controller 23, a USB controller 24, an embedded controller/keyboard controller (EC/KBC) 25, a keyboard (KB) 26, a pointing device 27, and the like.

The CPU 11 is a processor, which controls the operation of the computer 1. The CPU 11 executes an operating system (OS) and application programs, which are loaded from the HDD 21 or the like onto the main memory 13.

The CPU 11 also executes a basic input/output system (BIOS) stored in the flash BIOS-ROM 19. The flash BIOS-ROM 19 is a nonvolatile memory to store, for example, the BIOS and device information (parameters) required to begin using devices (hardware components) connected to the computer 1. The BIOS is a program for hardware control. The BIOS includes, for example, a boot control function to begin using devices connected to the computer 1. With this boot control function, when the computer 1 is booted, the configuration processing of devices connected to the computer 1 is executed to set the devices to be ready to use. Note that the devices connected to the computer 1 include those built in the computer 1 (for example, the graphics controller 14, network controller 20, card controller 23, USB controller 24, HDD 21, ODD 22, sound controller 17, LCD 15, a battery 32, etc.) and those externally connected to the computer 1 (for example, an externally connected HDD or ODD, a PC card 23A, a USB flash memory 24A, USB-connected peripheral devices, an externally connected LCD, etc.)

The north bridge 12 is a bridge device which connects between a local bus of the CPU 11 and the south bridge 16. The north bridge 12 incorporates a memory controller to control accesses to the main memory 13. The north bridge 12 also has a function of executing communications with the graphics controller 14.

The graphics controller 14 is a device to control the LCD 15 used as a display of the computer 1. A display signal generated by this graphics controller 14 is supplied to the LCD 15. The LCD 15 displays an image based on the display signal.

The south bridge 16 controls devices on a peripheral component interconnect (PCI) bus 2 and low pin count (LPC) bus 3. The south bridge 16 incorporates an integrated drive electronics (IDE) controller 16A required to control the HDD 21 and ODD 22, and a memory controller required to control accesses to the flash BIOS-ROM 19. Furthermore, the south bridge 16 has a function of executing communications with the sound controller 17 and network controller 20.

The sound controller 17 is a sound source device, and outputs audio data to be played back to the speakers 18A and 18B. The network controller 20 is a wired communication device to execute wired communications conforming to, for example, the Ethernet standard.

The USB controller 24 executes communications with an external device via a cable conforming to, for example, the USB2.0 standard. More specifically, the USE controller 24 controls, for example, data read accesses from the USB flash memory 24A and data write accesses to the USB flash memory 24A. The USB controller 24 can also control inputs using a USB-connected keyboard 24B. The card controller 23 executes communications with the connected PC card 23A.

The EC/KBC 25 is a one-chip microcomputer, which integrates an embedded controller for power management, and a keyboard controller to control the keyboard (KB) 26 and pointing device 27. This EC/KBC 25 has a function of turning the power supply of the computer 1 on and off in response to a user's operation. The EC/KBC 25 controls electric power supplied via a power supply circuit 31. This electric power is supplied from, for example, an external power supply connected via an AC adapter 33 or a battery 32. The EC/KBC 25 can detect a power supply state indicating whether or not electric power is supplied by the external power supply, whether or not electric power is supplied by the battery 32, and so forth.

The EC/KBC 25 stores information (to be also referred to as an initial boot flag hereinafter) indicating whether or not boot processing of the computer 1 is initial boot processing. The initial boot processing indicates, for example, first boot processing since the manufacture (delivery) (at a first power-on timing), and first boot processing since the power supply from the external power supply or battery 32 was disrupted. The EC/KBC 25 sets an initial boot flag in a period before the initial boot processing (for example, in a period since the manufacture until the beginning of use, or that after power supply from the external power supply or battery 32 was disrupted until the next use), and clears the initial boot flag in response to the initial boot processing of the computer 1. Therefore, whether or not the boot processing of the computer 1 is the initial boot processing can be determined depending on whether or not initial boot flag is set in the EC/KBC 25.

The EC/KBC 25 may further store information (parameter) (to be also referred to as a battery change flag hereinafter) indicating whether or not the battery 32 has been changed. The battery 32 connected to the computer 1 may often be changed. The EC/KBC 25 sets the battery change flag in response to, for example, change of the battery 32, and clears the battery change flag in response to the boot processing of the computer 1 after the battery 32 is changed. Therefore, whether or not the battery 32 connected to the computer 1 has been changed after the previous boot processing of the computer 1 can be determined according to whether or not the battery change flag is set in the EC/KBC 25. Note that the EC/KBC 25 can set the initial boot flag and battery change flag using, for example, an internal battery even when the computer 1 is off.

As described above, when the computer 1 is booted, the BIOS executes the configuration (initialization) processing of various devices connected to the computer 1. In this configuration processing, for example, device information indicating resources and the like required to begin using the devices has to be acquired by accessing the devices. However, since some devices are connected to the computer 1 via a low-speed interface (for example, the PCI bus 2), a whole period required to boot the computer 1 may be prolonged by waiting for processing for acquiring information from the devices. For this reason, this embodiment executes control to save device information detected in the initial boot processing in the nonvolatile memory (flash BIOS-ROM) 19, and to execute boot processing after the initial boot processing using the device information saved in the nonvolatile memory 19. In this manner, the boot period of the computer 1 can be shortened.

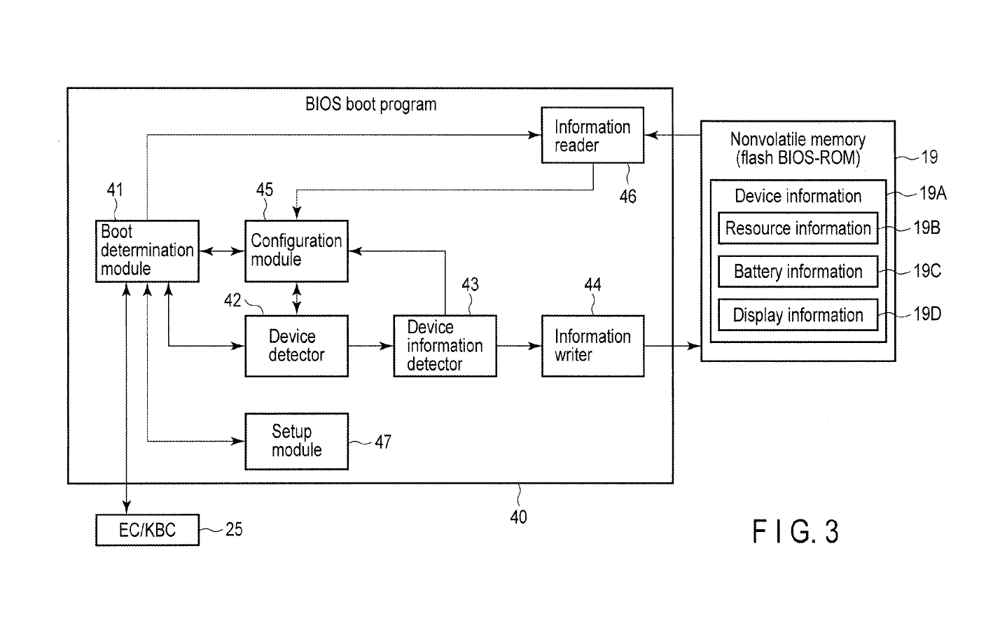

FIG. 3 shows an example of the functional configuration of a BIOS boot program 40 executed by the computer 1. The BIOS boot program 40 is a program included in the BIOS stored in the flash BIOS-ROM 19. Therefore, for example, the BIOS boot program 40 is loaded from the flash BIOS-ROM 19 onto the main memory 13, and is executed by the CPU 11.

The BIOS boot program 40 includes a boot determination module 41, a device detector 42, a device information detector 43, an information writer 44, a configuration module 45, an information reader 46, and a setup module 47.

The boot determination module 41 discriminates a boot timing of the computer 1 when, for example, the power supply of the computer 1 is turned on in response to pressing of the power button 28 (that is, when the computer 1 is booted). More specifically, the boot determination module 41 determines whether the computer 41 has been booted at a first timing or a second timing after the first timing. The first timing is, for example, a first boot timing of the computer 1 since the manufacture (delivery), or a first boot timing of the computer 1 since the power supply from the external power supply or battery 32 was disrupted. Note that boot processing at the first timing will also be referred to as initial boot processing hereinafter. The second timing is a timing of boot processing after the initial boot processing. The boot determination module 41 attains this determination with reference to the initial boot flag which is assured in the EC/KBC 25 and indicates whether or not the boot processing of the computer 1 is the initial boot processing.

When the boot determination module 41 determines that the computer 1 is booted at the first timing, it requests the device detector 42 to detect devices connected to the computer 1. When the boot determination module 41 determines that the computer 1 is booted at the second timing, it requests the information reader 46 to read device information 19A.

The operation executed when the computer 1 is booted at the first timing will be described first.

The device detector 42 detects devices connected to the computer 1 in response to the device detection request from the boot determination module 41. When a plurality of devices are connected to the computer 1, the device detector 42 sequentially detects these plurality of devices. Then, the device detector 42 notifies the device information detector 43 of the detected device.

The device information detector 43 detects device information 19A from the detected device in response to the notification from the device detector 42. More specifically, if the detected device is the display 15, the device information detector 43 detects display information 19D from the display 15. This display information 19D includes information indicating, for example, a display ID (EDID), display name, model number, and the like. If the detected device is the battery 32, the device information detector 43 detects battery information 19C from the battery 32. This battery information 19C includes information indicating, for example, a battery ID, battery name, battery capacity, model number, and the like. If the detected device is neither the display 15 nor the battery 32, the device information detector 43 detects resource information 19B from the device. This resource information 19B includes information indicating, for example, a device ID, device name, memory resources, memory I/O, and interrupt request (IRQ), which are to be assigned to the device, and the like. Then, the device information detector 43 outputs the detected display information 19D, battery information 19C, and resource information 19B to the information writer 44 and configuration module 45.

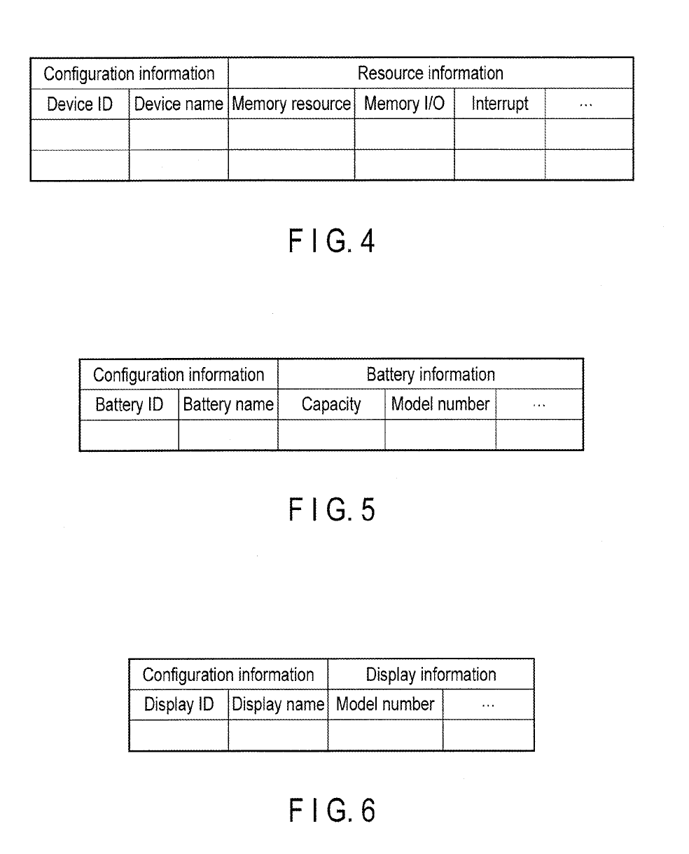

The information writer 44 stores the display information 19D, battery information 19C, and resource information 19B output from the device information detector 43 in the nonvolatile memory (flash BIOS-ROM) 19. Examples of the resource information 19B, battery information 190, and display information 19D to be stored will be described later with reference to FIGS. 4, 5, and 6.

The configuration module 45 sets the devices connected to the computer 1 to be ready to use using the display information 19D, battery information 19C, and resource information 19B output from the device information detector 43. For example, the configuration module 45 executes the configuration processing such as initialization of the device and assignment of memory resources to the device using the resource information 19B. The configuration module 45 also sets the battery 32 to be ready to use using the battery information 19C. Furthermore, the configuration module 45 sets the display 15 to be ready to use using the display information 19D. Then, the configuration module 45 notifies the boot determination module 41 that the devices are set to be ready to use.

The boot determination module 41 clears the initial boot flag included in the EC/KBC 25 in response to the notification from the configuration module 45.

Thus, the OS, which runs using the devices set to be ready to use, can be launched. The OS is loaded from, for example, the HDD 21 onto the main memory 13, and is executed.

Note that if the detected device is the USB controller 24, the configuration module 45 initializes the USB controller 24. Then, if a request that prompts the user to input a password (to be also referred to as a BIOS password hereinafter) is issued on the BIOS boot-up, the configuration module 45 notifies the boot determination module 41 that the devices are set to be ready to use after it waits for completion of the initialization processing that allows the USE-connected keyboard 24B, which may be used to input the BIOS password, to be ready to use. Furthermore, if the boot priority of a USB-connected device (for example, the USE flash memory 24A) is the top priority, the configuration module 45 notifies the boot determination module 41 that the devices are set to be ready to use after it waits for completion of the initialization processing which allows that USB-connected device to be ready to use.

With the above configuration, when the computer 1 is booted at the first timing (that is, in case of the initial boot processing), devices connected to the computer 1 are set to be ready to use, and the device information 19A used in the BIOS boot processing is saved in the nonvolatile memory 19.

The operation executed when the computer 1 is booted at the second timing will be described below.

The information reader 46 reads the device information 19A from the nonvolatile memory 19 in response to the read request of the device information 19A by the boot determination module 41. Then, the information reader 46 outputs the read device information 19A to the configuration module 45.

The configuration module 45 sets a plurality of devices connected to the computer 1 to be ready to use using the device information 19A output from the information reader 46. For example, the configuration module 45 executes, using the resource information 19B included in the device information 19A, the configuration processing of a device corresponding to that resource information 19B (an entry of the resource information 19B). The configuration module 45 assigns memory resources, a memory I/O, interrupt request, and the like to that device based on the resource information 19B. Also, the configuration module 45 sets the battery 32 to be ready to use using the battery information 19C in the device information 19A. Furthermore, the configuration module 45 sets the display 15 to be ready to use using the display information 19D in the device information 19A. Then, the configuration module 45 notifies the boot determination module 41 that the devices are set to be ready to use.

Note that if a device indicated by the device information 19A (resource information 19B) is the USB controller 24, the configuration module 45 initializes the USB controller 24. Then, if a request that prompts the user to input a BIOS password is issued on the BIOS boot-up, the configuration module 45 notifies the boot determination module 41 that the devices are set to be ready to use after it waits for completion of the initialization processing that allows the USE-connected keyboard 24B, which can be used to input the BIOS password, to be ready to use. Furthermore, if the boot priority of a USB-connected device (for example, the USB flash memory 24A) is the top priority, the configuration module 45 notifies the boot determination module 41 that the devices are set to be ready to use after it waits for completion of the initialization processing which allows that USB-connected device to be ready to use.

Thus, the OS, which runs using the devices set to be ready to use, can be launched. The OS is loaded from, for example, the HDD 21 onto the main memory 13, and is executed.

When the computer 1 is booted at the second timing, the battery 32 may have been changed after it was booted previously. In this case, the boot determination module 41 detects via the EC/KBC 25 that the battery 32 has been changed. Then, the boot determination module 41 notifies the device detector 42 that the battery 32 has been changed.

In response to the notification from the boot determination module 41, the device detector 42 detects a newly connected battery (changed battery) 32. The device detector 42 notifies the device information detector 43 of the detected new battery 32.

The device information detector 43 detects battery information 19C from the newly connected battery 32 in response to the notification from the device detector 42. The device information detector 43 outputs the detected battery information 19C to the configuration module 45 and information writer 44.

The configuration module 45 sets the new battery 32 to be ready to use using the battery information 19C output from the device information detector 43. Also, the information writer 44 stores the battery information 19C output from the device information detector 43 in the nonvolatile memory 19. The information writer 44 overwrites the battery information 19C corresponding to the battery 32 before the change by the battery information 19C corresponding to the changed battery 32.

With the above arrangement, when the computer 1 is booted at the second timing (that is, in case of the boot processing after the initial boot processing), since the configuration processing of the devices is executed using the device information 19A saved in the nonvolatile memory 19, a period required for the processing can be shortened compared to the initial boot processing, which executes the configuration processing after device information is detected from each device. For example, as for a device connected via a low-speed interface (bus), a period required to acquire information required to allow that device to be ready to use from the device unwantedly prolongs the whole boot period. For this reason, the device information 19A is saved in the nonvolatile memory 19 at the initial boot timing, and the device information 19A saved in the nonvolatile memory 19 is used at the next boot timing or later, thus speeding up the boot processing of the computer 1.

Note that when the computer 1 is booted, the boot determination module 41 detects a BIOS setup instruction required to change the configuration of devices connected to the computer 1 in response to, for example, a predetermined key input. In this case, the boot determination module 41 requests the setup module 47 to start BIOS setup processing.

The setup module 47 displays a setup screen in response to the request from the boot determination module 41. The setup screen allows the user to set to, for example, permit or inhibit use of each of the devices connected to the computer 1 (that is, to enable or disable each device) in accordance with the user's input (operation). Then, when the setup processing is complete, the setup module 47 reboots the computer 1 and notifies the boot determination module 41 that the configuration of the devices connected to the computer 1 has been changed.

When the boot determination module 41 detects, in response to the notification from the setup module 47, that the configuration of the devices connected to the computer 1 has been changed, it handles the boot (reboot) processing after the device configuration has been changed in the same manner as the aforementioned boot processing (initial boot processing) at the first timing. Then, the operation when the computer 1 is booted at the first timing is executed, as described above. Thus, when the computer 1 is booted after the device configuration has been changed by the BIOS setup processing, device information is detected again from each device connected to the computer 1, and that device is set to be ready to use. Also, using the detected device information, the device information 19A saved in the nonvolatile memory 19 is updated. Therefore, even when the device configuration has been changed, the computer 1 can be normally booted. Furthermore, in the boot processing after the boot processing immediately after the BIOS setup processing (that is, that at the second timing), the computer 1 can be booted quickly using the updated device information 19A.

Note that the setup module 47 may store information indicating whether or not the device configuration has been changed (device configuration change flag) in the nonvolatile memory 19 in place of notifying the boot determination module 41 that the device configuration has been changed by the setup processing. In this case, the boot determination module 41 reads the device configuration change flag stored in the nonvolatile memory 19 in response to the boot processing of the computer 1. Then, the boot determination module 41 handles that boot processing as that at the first timing (initial boot processing) if the device configuration change flag is set.

FIGS. 4, 5, and 6 show examples of the device information 19A. The device information 19A includes, for example, the resource information 19B, battery information 19C, and display information 19D, as described above.

FIG. 4 shows an example of the resource information 19B corresponding to a device (hardware) connected to the computer 1. This device corresponds to, for example, the graphics controller 14, network controller 20, card controller 23, USB controller 24, HDD 21, ODD 22, sound controller 17, and the like.

The resource information 19B includes a plurality of entries corresponding to a plurality of devices. An entry corresponding to a certain device includes, for example, device ID, device name, memory resources, memory I/O, and interrupt. “Device ID” indicates identification information uniquely assigned to that device. “Device name” indicates the name of that device. “Memory resources” indicate the memory range assigned to that device. “Memory I/O” indicates the memory I/O range assigned to that device. “Interrupt” indicates the interrupt request generated when that device calls the CPU 11. Note that “device ID” and “device name” will also be referred to as device configuration information hereinafter. “Memory resources”, “memory I/O”, and “interrupt” will also be referred to as resource information hereinafter.

FIG. 5 shows an example of the battery information 19C corresponding to the battery 32. A battery connected to the computer 1 is often changed by the user. Also, batteries to be changed often have different capacities. For this reason, the battery information 19C corresponding to the battery 32 is updated after the battery is changed.

The battery information 19C includes an entry corresponding to the battery 32 connected to the computer 1. The entry corresponding to the battery 32 includes, for example, battery ID, battery name, capacity, model number, and the like. “Battery ID” indicates identification information uniquely assigned to the battery 32. “Battery name” indicates the name of the battery 32. “Capacity” indicates the charging capacity of the battery 32. “Model number” indicates the model number of the battery 32 given by, for example, a vendor.

FIG. 6 shows an example of the display information 19D corresponding to the display 15. The display (display panel) 15 connected to the computer 1 may often be changed by the user. When the display 15 is changed, it is assumed that no electric power is supplied from the external power supply or battery 32 (for example, it is assumed that electric power is stopped for the purpose of easy operation and safety). For this reason, the display information 19D corresponding to the display 15 is updated after the power supply is disrupted.

The display information 19D includes an entry corresponding to the display 15 connected to the computer 1. The entry corresponding to the display 15 includes, for example, display ID, display name, model number, and the like. “Display ID” indicates identification information uniquely assigned to the display 15. This identification information is, for example, an extended display identification data (EDID). “Display name” indicates the name of the display 15. “Model number” indicates the model number of the display 15 given by, for example, a vendor.

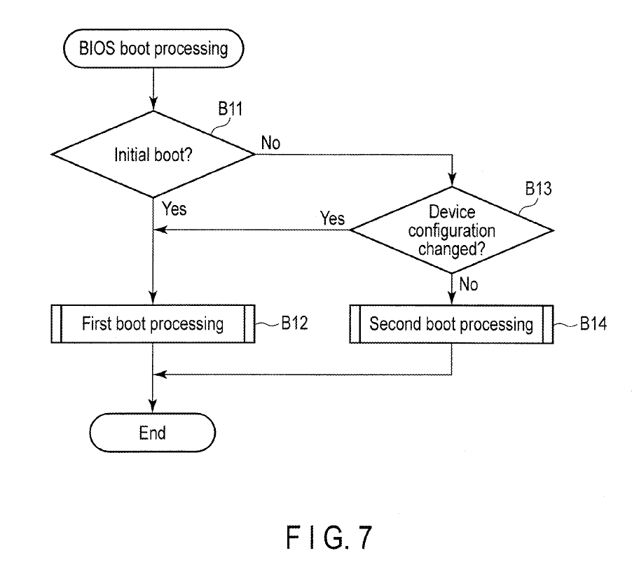

The procedure of BIOS boot processing executed by the BIOS boot program 40 will be described below with reference to the flowchart shown in FIG. 7.

Initially, in response to a boot instruction of the computer 1, the boot determination module 41 determines whether or not the boot processing of the computer 1 is the initial boot processing (that is, whether or not the computer 1 is booted at the first boot timing) (block B11). The first timing is a first boot timing since the manufacture (delivery) or that since the power supply from the external power supply or battery 32 was disrupted. The boot determination module 41 attains this determination with reference to the initial boot flag which is set in, for example, the EC/KBC 25, and indicates whether or not the initial boot processing of the computer 1 is executed.

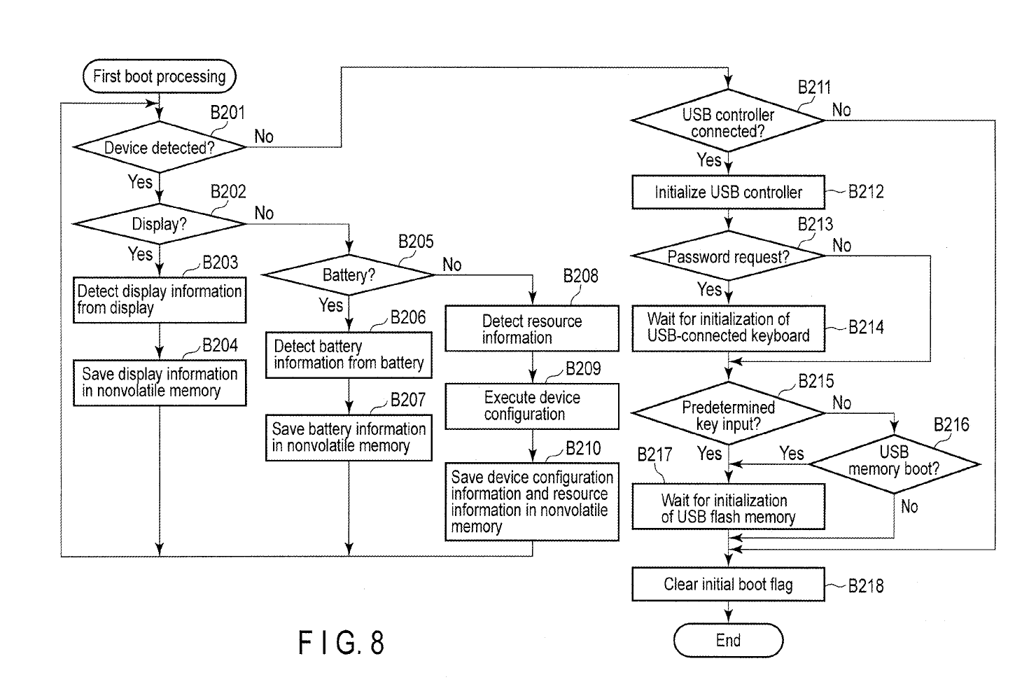

If the boot processing of the computer 1 is the initial boot processing (YES in block B11), the BIOS boot program 40 (computer 1) executes first boot processing (block B12). More specifically, the boot determination module 41 instructs the respective modules in the BIOS boot program 40 to execute the first boot processing. The procedure of the first boot processing will be described later with reference to the flowchart shown in FIG. 8.

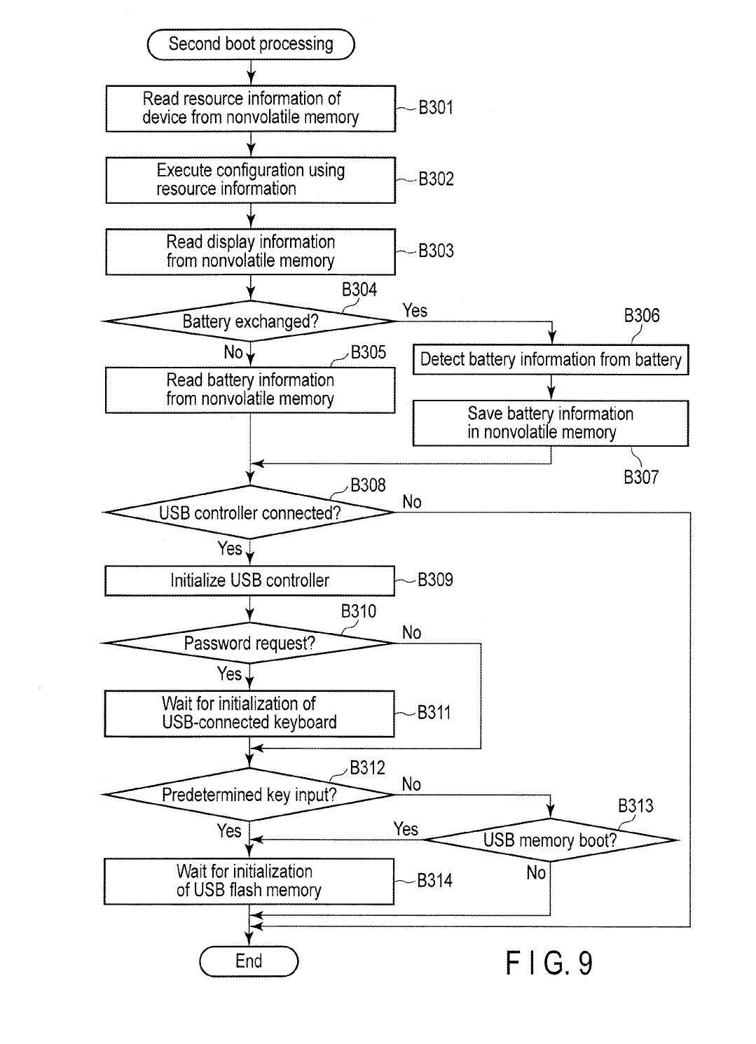

If the boot processing of the computer 1 is not the initial boot processing (NO in block B11), the boot determination module 41 determines whether or not the device configuration (hardware configuration) used by the computer 1 has been changed (block B13). If the device configuration used by the computer 1 has been changed (YES in block B13), the BIOS boot program 40 executes the first boot processing (block B12). On the other hand, if the device configuration used by the computer 1 has not been changed (NO in block B13), the BIOS boot program 40 executes second boot processing (block B14). More specifically, the boot determination module 41 instructs the respective modules in the BIOS boot program 40 to execute the second boot processing. The procedure of the second boot processing will be described later with reference to the flowchart shown in FIG. 9.

An example of the procedure of the first boot processing will be described below with reference to the flowchart shown in FIG. 8.

The device detector 42 determines whether or not a device (hardware) connected to the computer 1 is detected (block B201). If the device connected to the computer 1 is detected (YES in block B201), the device information detector 43 determines whether or not the detected device is the display (LCD) 15 (block B202). If the detected device is the display 15 (YES in block B202), the device information detector 43 detects the display information 19D from the display 15 (block B203). Then, the information writer 44 saves the detected display information 19D in the nonvolatile memory 19 (block B204).

If the detected device is not the display 15 (NO in block B202), the device information detector 43 determines whether or not that device is the battery 32 (block B205). If the detected device is the battery 32 (YES in block B205), the device information detector 43 detects the battery information 19C from the battery 32 (block B206). Then, the information writer 44 saves the detected battery information 19C in the nonvolatile memory 19 (block B207).

If the detected device is not the battery 32 (NO in block B205), the device information detector 43 detects the resource information 19B from the device (block B208). Then, the configuration module 45 executes configuration processing such as assignment of memory resources using the detected resource information 19B (block B209). Also, the information writer 44 saves the resource information 19B corresponding to the device in the nonvolatile memory 19 (block B210).

After the device information 19A (display information 19D, battery information 19C, or resource information 19B) is saved in the nonvolatile memory 19 in block B204, B207, or B210, the process returns to block B201 to determine again whether or not a device connected to the computer 1 is detected. That is, the processes in blocks B201 to B210 are executed for each of the devices connected to the computer 1.

If a device connected to the computer 1 is not detected (that is, detection of all devices connected to the computer 1 is complete) (NO in block B201), the configuration module 45 determines whether or not the devices connected to the computer 1 include the USB controller 24 (block B211). If no USB controller 24 is connected (NO in block B211), the boot determination module 41 clears the initial boot flag set in the EC/KBC 25 (block B218), thus ending the processing.

If the USB controller 24 is connected (YES in block B211), the configuration module 45 initializes the USB controller 24 (block B212). Then, the configuration module 45 determines whether or not a request that prompts the user to input a BIOS password is issued at the BIOS boot timing (block B213). If the BIOS password input request is issued (YES in block B213), the configuration module 45 waits for completion of initialization processing required to set the USB-connected keyboard 24B, which is used to input the BIOS password, to be ready to use (block B214).

After the initialization processing of the USB-connected keyboard 24B is complete in block B214 or if no BIOS password input request is issued (NO in block B213), the configuration module 45 determines whether or not a predetermined key input is made to issue a boot (USE memory boot) instruction for an OS stored in the USB flash memory 24A (block B215). If no predetermined key input is made (NO in block B215), the configuration module 45 determines whether or not a USB memory boot instruction is set by the BIOS setup processing or the like (block B216). Then, if the predetermined key input is made (YES in block B215) or if the USB memory boot instruction is set (YES in block B216), the configuration module 45 waits for completion of initialization processing required to set the USB flash memory 24A to be ready to use (block B217).

After completion of the initialization processing of the USB flash memory 24A in block B217, or if no USB memory boot instruction is set (NO in block B216), the boot determination module 41 clears the initial boot flag set in the EC/KBC 25 (block B218), thus ending the processing.

With the aforementioned processing, in the initial boot processing of the computer 1 (in the boot processing at the first timing), devices connected to the computer 1 are made available, and the device information 19A used in the BIOS boot processing can be saved in the nonvolatile memory 19.

FIG. 9 is a flowchart showing an example of the sequence of the second boot processing.

The information reader 46 reads the resource information 19B of the device from the nonvolatile memory 19 (block B301). Then, the configuration module 45 executes configuration processing of the device using the read resource information 19B (block B302). The information reader 46 then reads the display information 19D corresponding to the display 15 from the nonvolatile memory 19 (block B303).

Next, the boot determination module 41 determines whether or not the battery 32 was changed after the previous boot processing of the computer 1 (block B304). More specifically, the boot determination module 41 determines via the EC/KBC 25 whether or not the battery 32 was changed. If the battery 32 was not changed (NO in block B304), the information reader 46 reads the battery information 19C from the nonvolatile memory 19 (block B305).

On the other hand, if the battery 32 was changed (YES in block B304), the device detector 42 detects the changed battery 32, and the device information detector 43 detects the battery information 19C from that battery 32 (block B306). Then, the information writer 44 saves the detected battery information 19C in the nonvolatile memory 19 (block B307).

Then, the configuration module 45 determines whether or not the devices connected to the computer 1 include the USB controller 24 (block B308). If no USB controller 24 is connected (NO in block B308), the processing ends.

If the USB controller 24 is connected (YES in block B308), the configuration module 45 initializes the USB controller 24 (block B309). Then, the configuration module 45 determines whether or not a request that prompts the user to input a BIOS password is issued at the BIOS boot timing (block B310). If the BIOS password input request is issued (YES in block B310), the configuration module 45 waits for completion of the initialization processing required to set the USB-connected keyboard 24B, which is used to input the BIOS password, to be ready to use (block B311).

After completion of the initialization processing of the USB-connected keyboard 24B in block B311 or if no BIOS password input request is issued (NO in block B310), the configuration module 45 determines whether or not a predetermined key input is made to issue a boot (USB memory boot) instruction of an OS stored in the USB flash memory 24A (block B312). If no predetermined key input is made (NO in block B312), the configuration module 45 determines whether or not a USB memory boot instruction is set by the BIOS setup processing or the like (block B313). Then, if the predetermined key input is made (YES in block B312) or if the USB memory boot instruction is set (YES in block B313), the configuration module 45 waits for completion of initialization processing required to set the USB flash memory 24A to be ready to use (block B314).

After completion of the initialization processing of the USB flash memory 24A in block B314, or if no USB memory boot instruction is set (NO in block B313), the boot determination module 41 ends the processing.

With the aforementioned processing, in the boot processing after the initial boot processing (the boot processing at the second timing), devices connected to the computer 1 are made available using the device information 19A saved in the nonvolatile memory 19. After completion of this BIOS boot processing, the OS, which is loaded from the HDD 21 or USB flash memory 24A onto the main memory 13, is executed (launched).

As described above, according to this embodiment, the boot period can be shortened without impairing convenience. The BIOS boot program 40 saves the device information 19A detected in the initial boot processing in the nonvolatile memory 19, and executes the boot processing using the device information 19A saved in the nonvolatile memory 19 in the boot processing after the initial boot processing. Then, the boot processing of the computer 1 can be speeded up without limiting functions available at the boot timing. Therefore, the user's convenience can be prevented from being impaired, and no operation that prompts the user to select a special mode for shortening the boot period is requested.

Note that all the procedures of the BIOS boot processing according to this embodiment can be implemented by software. For this reason, by only installing and executing a program required to implement the procedures of the BIOS boot processing in a normal computer via a computer-readable storage medium storing that program, the same effects as in this embodiment can be easily realized.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus, to which devices are connected, comprising:
a device information detector configured to detect a plurality of pieces of device information from the devices when the information processing apparatus is booted at a first timing, the plurality of pieces of device information being for setting the devices to be ready to use;
a device setting module configured to set the devices to be ready to use using the plurality of pieces of device information; and
a device information storage module configured to store the plurality of pieces of device information in a nonvolatile memory,
wherein the device setting module is configured to set the devices to be ready to use using the plurality of pieces of device information in the nonvolatile memory when the information processing apparatus is booted at a second timing after the first timing.

2. The information processing apparatus of claim 1, wherein the first timing is a timing when the information processing apparatus is initially booted.

3. The information processing apparatus of claim 1, further comprising a power supply state detector configured to detect whether electric power is supplied from an external power supply to the information processing apparatus and whether electric power is supplied from a battery to the information processing apparatus,
wherein the first timing is a timing when the information processing apparatus is initially booted after it is detected that no electric power is supplied from the external power supply and the battery to the information processing apparatus.

4. The information processing apparatus of claim 3, wherein the power supply state detector is configured to further detect that the battery was changed, and
the first timing is a timing when the information processing apparatus is initially booted after the power supply state detector detects that the battery was changed.

5. The information processing apparatus of claim 1, wherein the plurality of pieces of device information comprise information indicative of memory resources to be assigned to the devices.

6. The information processing apparatus of claim 1, wherein the devices comprise a display device, and
the plurality of pieces of device information comprise identification information of the display device.

7. The information processing apparatus of claim 1, wherein the devices comprise a battery, and
the plurality of pieces of device information comprise information indicative of a capacity of the battery.

8. The information processing apparatus of claim 1, further comprising a setup module configured to change a configuration of the devices,
wherein the first timing is a timing when the information processing apparatus is initially booted after the configuration of the devices was changed.

9. The information processing apparatus of claim 1, wherein the devices comprise a device incorporated in the information processing apparatus.

10. The information processing apparatus of claim 1, wherein the devices comprise a device externally connected to the information processing apparatus.

11. A boot control method of controlling boot of an information processing apparatus, to which devices are connected, the method comprising:
detecting a plurality of pieces of device information from the devices when the information processing apparatus is booted at a first timing, the plurality of pieces of device information being for setting the devices to be ready to use;
setting the devices to be ready to use using the plurality of pieces of device information; and
storing the plurality of pieces of device information in a nonvolatile memory,
wherein the setting comprises setting the devices to be ready to use using the plurality of pieces of device information in the nonvolatile memory when the information processing apparatus is booted at a second timing after the first timing.
